(19) United States
(12) Patent Application Publication
(10) Pub. No.: US 2026/0351562 A1
(43) Pub. Date: Nov. 5, 2026

(54) Rechargeable Composite Electrodes and Methods Thereof

(71) Applicant: University of Maryland, College Park, College Park, MD (US)

(72) Inventors: Chunsheng Wang, Silver Spring, MD (US); Jijian Xu, College Park, MD (US); Guorui Cai, College Park, MD (US); Nan Zhang, College Park, MD (US)

(21) Appl. No.: 19/486,948

(22) PCT Filed: May 22, 2024
(86) PCT No.: PCT/US2024/030625

§ 371 Date: Nov. 23, 2025

Related U.S. Application Data
(60) Provisional application No. 63/503,953, filed on May 23, 2023.
(60) Provisional application No. 63/650,324, filed on May 21, 2024.

(51) Int. Cl. H01M 4/36; H01M 4/02; H01M 4/38; H01M 4/40; H01M 4/58; H01M 4/583; H01M 4/587; H01M 10/052; H01M 10/0563; H01M 10/0567; H01M 10/0568; H01M 10/0569

(52) U.S. Cl. CPC H01M 4/364; H01M 4/382; H01M 4/405; H01M 4/582; H01M 4/5835; H01M 4/587; H01M 10/052; H01M 10/0563; H01M 10/0567; H01M 10/0568; H01M 10/0569; H01M 2004/021; H01M 2004/027; H01M 2004/028; H01M 2300/002; H01M 2300/0034

(57) ABSTRACT

This present disclosure is directed to composite cathode compositions, liquid electrolyte compositions, and rechargeable batteries comprising said novel cathode compositions and electrolyte compositions.

### CROSS REFERENCE TO RELATED APPLICATIONS

This application claims priority to U.S. Application No. 63/503953, filed on May 23, 2023 and U.S. Application No. 63/650,324, filed on May 21, 2024, the contents of which are hereby incorporated by reference in its entirety.

### FIELD OF THE INVENTION

The field of the invention relates generally to batteries and battery components, and more particularly to composite cathode compositions, liquid electrolyte compositions, and the rechargeable electrochemistry of the batteries with these components.

### BACKGROUND

This background information is provided for the purpose of making information believed by the applicant to be of possible relevance to the present invention. No admission is necessarily intended, nor should it be construed, that any of the information disclosed herein constitutes prior art against the present invention.

Driven by the increasing demands on electric vehicles and energy storage applications, there is a pressing need to explore new battery chemistry that offers a high energy density. Nowadays, the cell energy density is largely restricted by conventional layered transition metal oxide cathodes (LiMO₂, M=Ni, Co, Mn, etc.) with a low capacity (<220 mAh/g). Primary CFₓ batteries offer the highest energy density (theoretically 2189 Wh/kg), but they are not rechargeable. Extensive research has established that CFₓ undergoes a transformation into LiF and carbon upon its reaction with lithium, as expressed by the equation CFₓ+Li→LiF+C.

Making CFₓ cells reversible involves driving the electrochemical reaction involving LiF. Inspired by the concept of redox coupling, LiF coupled with LiCl, LiBr, and LiI, respectively, was systematically investigated. It's reasonable to expect that the formed interhalogen inorganic compounds (e.g. ClF, BrF, and IF) are able to form interhalogens just like BrCl, which greatly reduces the energy required to drive LiF-involved reactions. It is also worth mentioning that LiF-based composites correspond to higher work voltage, which means higher energy density. In the view of LiF, the theoretical capacity of LiF is 1030 mAh/g, which is much higher than that of LiCl (632 mAh/g) and LiBr (309 mAh/g).

Herein, the first reversible CFₓ chemistry is disclosed, which holds the potential to vastly boost the operation voltage and energy density of next-generation batteries. Ex-situ XRD spectroscopy reveals the reversible vanishing and formation of LiF upon charging and discharging, respectively. These results provide insights into reversible CFₓ chemistry and its great potential in achieving high-energy batteries.

### BRIEF DESCRIPTION OF THE FIGURES

The following drawings form part of the present specification and are included to further demonstrate certain aspects of the present invention. The invention may be better understood by reference to one or more of these drawings in combination with the detailed description of specific embodiments presented herein. The patent or application file contains at least one drawing executed in color. Copies of this patent or patent application publication with color drawing(s) will be provided by the Office upon request and payment of the necessary fee.

FIG. 1. FIG. 1 displays XRD patterns of the LiF—LiI-Graphite (FIG) electrode in various charging and discharging states.

FIGS. 2A-2H. FIG. 2 displays the results of elemental analysis imaging. FIG. 2A displays a typical SEM image of initial LiF—LiI-Graphite (FIG) electrode. FIGS. 2B-2D display corresponding EDS mapping of the elements C, I, and F, respectively. FIG. 2E displays an SEM image of a fully charged FIG electrode. FIGS. 2F-2H displays corresponding EDS mapping of the elements C, I, and F, respectively.

FIGS. 3A-3B. FIG. 3A displays the electrochemical performance of CFₓ—LiI (CFI)∥Li cells. FIG. 3B displays the electrochemical performance of LiF—LiI-Graphite (FIG)∥Li cells. These demonstrate the reversibility of LiF-based electrochemistry.

FIG. 4. FIG. 4 displays the performance of the FIG cathode in a commercial electrolyte. The electrolyte used was 1 M LiPF₆ in ethylene carbonate and diethyl carbonate in a 1 -to-1 volumetric ratio.

Particular non-limiting embodiments of the present invention will now be described with reference to accompanying drawings.

### DESCRIPTION

### 1.0 Definitions

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.” As used herein, the term “about” refers to a ±10% variation from the nominal value. It is to be understood that such a variation is always included in any given value provided herein, whether or not it is specifically referred to.

Recitation of ranges of values herein are merely intended to serve as a shorthand method of referring individually to each separate value falling within the range, unless otherwise indicated herein, and each separate value is incorporated into the specification as if it were individually recited herein. Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Moreover, all ranges disclosed herein are to be understood to encompass any and all subranges (including all fractional and whole values) subsumed therein.

As used herein, “CFₓ cathode composition” refers to a composition, which contains graphite, to be used as a cathode in a battery, and wherein upon charge/discharge of said battery generates CFx in situ. Further, the CFx cathode composition as described herein is used in rechargeable batteries.

The term “composite cathode composition” refers to and is used interchangeably with the term “composite cathode”. In some embodiments, composite cathode composition disclosed includes electronic conductive additives and ionic conductive fillers, such as SSE, in addition to the active materials.

As used herein, “small-sized lithium salt” refers to lithium salts with anions wherein the anions in such a salt are in relatively small in size, for example, with a size in the range of about 0.1 nm to about 1 nm. Examples include LiPF₆ (lithium hexafluorophosphate), LiFSI (lithium bis(fluorosulfonyl)imide), LiTFSI (lithium bis(trifluoromethanesulfonyl)imide). Without wishing to be limited to any particular theory, anions such as PF₆⁻, FSI⁻, and TFSI⁻ usually have a single central atom (P, N, etc.) and the carbon chain (if there is) in these anions are typically limited to about 1-2 carbon atoms, contributing to their small size.

As used herein, “large-sized anions” refers to lithium salts with anions wherein the anions in such a salt are in relatively large in size, for example, with a size in the range of about 1 nm to about 2 nm. Examples include lithium bis(nonafluorobutanesulfonyl)imide (LiNFSI), lithium tetraphenylborate tris(1,2-dimethoxyethane), lithium p-toluenesulfinate, lithium nonafluoro-1-butanesulfonate, lithium 1,1,2,2,3,3-hexafluoropropane-1,3-disulfonimide, lithium 2-[(4-methylpiperazin-1-yl)methyl]benzoate, lithium 4,5-dicyano-2-(trifluoromethyl)imidazol-1-ide. These salts may contain anions with extended carbon chains or bulky substituents, contributing to their larger molecular size.

Transition metals and transition metal compounds are typically present in commercial batteries, which can potentially cause pollution to the environment. One advantage of the present invention is that batteries “free of” and “substantially free of” transition metals comprising compositions disclosed herein may be prepared. As used herein, the term “substantially free of transition metals” refers to compositions disclosed with no more than trace amounts of transition metals. As used herein, the term “free of transition metals” refers to compositions disclosed herein with 0 wt % of transition metals, i.e., there is no detectable amounts of transition metals. Detection the presence of transition metals (or their absence) may be determined using standard methods known in the art.

As used herein, the term “substantially free of water” refers the presence of no more than “trace amounts” of water. As used herein, the term “free of water” refers the absence of water, there is no detectable amounts of water present (beyond moisture based on humidity of the ambient environment). Detection the amount of water (or its absence) may be determined using standard methods known in the art.

Common laboratory techniques to render a solution, solvent, or liquid component substantially free of water are known. Techniques such as this may include preparing such solution, solvent, or liquid component in a dry room, in a water-free autoclave, in a water-free container filled with inert-gas in a water-free glovebox, which may optionally be air-free, storing under activated molecular sieves, etc.

As used herein, the term “SOC” refers to the state-of-charge of a battery. For example, 100% SOC means the battery is fully charged, 0% SOC means the battery is fully discharged, and 40% SOC means the charged capacity is 40% of the full capacity. Further, “fully charged”, as used herein, refers to the state of a battery when it has reached its designed maximum capacity to store electrical energy. Fully charged batteries are ready for use and can deliver their designed maximum available energy when needed. Likewise, “fully discharged”, as used herein, refers to the state of a battery when it has been depleted of its stored electrical energy to the maximum extent possible. Fully discharged batteries have no remaining usable energy and need to be recharged before further use.

One aspect of the present disclosure pertains to a composite cathode composition, said cathode composition comprising:
a. graphite;
b. a component chosen from a monocationic metal fluoride or CFₓ, and;
c. at least one salt chosen from MCI, MBr, MI, or a combination thereof;
wherein M may be Li⁺, Na⁺, K⁺, or other monocationic metals;
and wherein x is in the range of about 0.05 to about 1.1.

In some embodiments, x is in the range of about 0.2 to about 1.

In some embodiments, said salt is chosen from MI, MBr, MCl, or a combination thereof. For example, said salt may be LiI, NaI, KI, or a combination thereof. In some embodiments, said salt may be present as particles. In such cases, said particles may have a size in the range of about 1 nm to about 100 μm, or a size in the range of about 10 nm to about 10 μm, or said particles may have a size of about 10 μm.

In some embodiments, said composition disclosed herein is substantially free of transition metals. In further embodiments, said composition disclosed herein is free of transition metals.

Another aspect of the present disclosure pertains to a liquid electrolyte, said liquid electrolyte comprising a partially fluorinated solvent system, one or more salts comprising large-sized anions, and one or more salt additives comprising small-sized lithium salts. In some embodiments, said partially fluorinated solvent system is chosen from methyl (2,2,2-trifluoroethyl) carbonate, ethyl-(2,2,2-trifluoroethyl) carbonate, fluoroethylene carbonate, bis(2,2,2-trifluoroethyl) ether, 1,2-bis(2-fluoroethoxy)ethane, methyl 3,3,3-trifluoropionate, methyl difluoroacetate, methyl 2,2-difluoro-2 (fluorosulfonyl)acetate, ethyl difluoroacetate, or combinations thereof. In other embodiments, said one or more salts comprising large-sized anions is chosen from lithium bis(nonafluorobutanesulfonyl)imide (LiNFSI), lithium tetraphenylborate tris(1,2-dimethoxyethane), lithium p-toluenesulfinate, lithium nonafluoro-1-butanesulfonate, lithium 1,1,2,2,3,3-hexafluoropropane-1,3-disulfonimide, lithium 2-[(4-methylpiperazin-1-yl)methyl]benzoate, lithium 4,5-dicyano-2-(trifluoromethyl)imidazol-1-ide, or combinations thereof. In further embodiments, said one or more salt additives comprising small-sized lithium salts is chosen from LiPF₆, lithium bis(fluorosulfonyl)imide (LiFSI), lithium difluorophosphate (LiDFP), lithium tetrafluoroborate (LiBF₄), lithium bis(trifluoromethanesulfonyl)imide (LiTFSI), lithium nitrate (LiNO₃), lithium trifluoromethanesulfonate, or combinations thereof. In some embodiments, said electrolyte disclosed herein is substantially free of water. In further embodiments, said electrolyte disclosed herein is free of water.

In some embodiments, the concentration of said one or more salts and said one or more salt additives are in the range of about 0.05 M to about 7 M, or from about 0.05 M to about 2 M, or from about 3 M to about 7 M, or is about 2 M.

An additional aspect of the present disclosure pertains to a battery, said battery comprising a composite CFₓ cathode composition as described previously, an anode, and a liquid electrolyte as described previously. In some embodiments, said anode is chosen from Li metal, Li foil, and Li alloy foil, or combinations thereof. Li alloy foil may comprise Li and an additional element chosen from Al, Si, Mg, Sn, and Bi. Said additional element may be present in the alloy in the range of about 20% to 70% by weight.

In some embodiments, the battery is rechargeable. The inventors surprisingly found that batteries utilizing the cathode compositions of the present disclosure were rechargeable, which is typically not feasible for CFₓ batteries.

In other embodiments, the battery has a charging capacity in the range of about 200 mAh/g to about 500 mAh/g. In other embodiments, the battery has a discharge capacity in the range of about 200 mAh/g to about 500 mAh/g.

Another aspect of the present disclosure pertains to a method of assembling a battery, said method comprising layering of a cathode composition disclosed herein, a separator material, the anode, and the electrolyte disclosed herein. In some embodiments, the battery is a coin cell/pouch cell/full cell battery, etc.

Another aspect of the present disclosure pertains to a method of supplying power, said method comprising using a battery disclosed herein to supply a voltage in the range of about 2 to about 5 V. The inventors also surprisingly found that batteries utilizing the cathode compositions disclosed herein in the presence of the liquid electrolytes disclosed herein is able to supply voltages in the range of about 2 V to about 5 V. Similar commercial batteries typically reach voltage output maximums of up to 4.5 V. However, the batteries of the present disclosure may reach up to 5 V. One of skill in the art would also recognize that a difference in voltage output of 0.5 V, as in between 4.5 V and 5.0 V for example, would be considered a large gap which would not otherwise be easily surmountable.

### 2.0 Non-Limiting Embodiments

### List of Embodiments

The following is a list of non-limiting embodiments.
1. A composite cathode composition, said composition comprising:
   a. graphite;
   b. a component chosen from a monocationic metal fluoride or CFₓ, and;
   c. at least one salt chosen from MCl, MBr, and MI, or a combination thereof; wherein M is Li⁺, Na⁺, K⁺, or other monocationic metals;
2. and wherein x is in the range of about 0.05 to about 1.1. The composition of embodiment 1, wherein x is in the range of about 0.2 to 1.
3. The composition of embodiment 1, wherein said salt is chosen from MI, MBr, MCl, or a combination thereof.
4. The composition of embodiment 3, wherein said salt is LiI, NaI, or KI, MBr, or a combination thereof.
5. The composition of embodiment 3, wherein said salt is in the form of particles.
6. The composition of embodiment 5, wherein said particles have a size in the range of about 1 nm to about 100 μm.
7. The composition of embodiment 5, wherein said particles have a size in the range of about 10 nm to about 10 μm.
8. The composition of embodiment 5, wherein said particles have a size of about 10 μm.
   The composition of embodiment 1, wherein said composite electrode composition is substantially free from transition metals, or is free from transition metals.
   In some embodiments, said cathode composition of any of the preceding embodiments further comprises one or more electronic conductive additives and one or more ionic conductive fillers, such as SSE
9. A liquid electrolyte, said liquid electrolyte comprising a partially fluorinated solvent system, one or more salts comprising large-sized anions, and one or more salt additives comprising small-sized lithium salts.
10. The liquid electrolyte of embodiment 10, wherein said partially fluorinated solvent system is chosen from methyl (2,2,2-trifluoroethyl) carbonate, ethyl-(2,2,2-trifluoroethyl) carbonate, fluoroethylene carbonate, bis(2,2,2-trifluoroethyl) ether, 1,2-bis(2-fluoroethoxy)ethane, methyl 3,3,3-trifluoropionate, methyl difluoroacetate, methyl 2,2-difluoro-2 (fluorosulfonyl)acetate, ethyl difluoroacetate, or combinations thereof.
11. The liquid electrolyte of embodiment 10, wherein said one or more salts comprising large-sized anions is chosen from lithium bis(nonafluorobutanesulfonyl)imide (LiNFSI), lithium tetraphenylborate tris(1,2-dimethoxyethane), lithium p-toluenesulfinate, lithium nonafluoro-1-butanesulfonate, lithium 1,1,2,2,3,3-hexafluoropropane-1,3-disulfonimide, lithium 2-[(4-methylpiperazin-1-yl)methyl]benzoate, lithium 4,5-dicyano-2-(trifluoromethyl)imidazol-1-ide, or combinations thereof.
12. The liquid electrolyte of embodiment 10, wherein said one or more salt additives comprising small-sized lithium salts is chosen from LiPF₆, lithium bis(fluorosulfonyl)imide (LiFSI), lithium difluorophosphate (LiDFP), lithium tetrafluoroborate (LiBF₄), lithium bis(trifluoromethanesulfonyl)imide (LiTFSI), lithium nitrate (LiNO₃), lithium trifluoromethanesulfonate, or combinations thereof.
13. The liquid electrolyte of embodiment 10, wherein the concentration of said one or more salts and said one or more salt additives is in the range of about 0.05 M to about 7 M, or is in the range of about 0.05 M to about 2 M, or is in the range of about 3 M to about 7 M, or is about 2 M.
14. The liquid electrolyte of embodiment 10, wherein said liquid electrolyte is substantially free of water.
15. A battery, said battery comprising a cathode composition of any of the preceding embodiments.
16. The battery of embodiment 16, said battery further comprising a liquid electrolyte of any of the preceding embodiments.
17. The battery of embodiment 17, said battery further an anode.
18. The battery of any of the preceding embodiments, said battery comprising a cathode composition of any of the preceding embodiments, a liquid electrolyte of any of the preceding embodiments, and an anode.
19. The battery of any of the preceding embodiments, wherein the anode is chosen from Li metal, Li foil, Li alloy foil, or combinations thereof.

20. The battery of embodiment 20, wherein said Li alloy foil comprises Li and an additional element chosen from Al, Si, Mg, Sn, and Bi. In some embodiments, said additional element is present in the alloy in the range of about 20% to about 70% by weight.
21. The battery of embodiment of any of the preceding embodiments, wherein said battery is rechargeable.
22. The battery of embodiment 16, wherein said battery has a charging capacity in the range of about 200 mAh/g to about 500 mAh/g.
23. The battery of embodiment 16, wherein said battery has a discharge capacity in the range of about 200 mAh/g to about 500 mAh/g.
24. A method of assembling a battery, said method comprising layering of a cathode composition of any of the preceding embodiments. In further embodiments, said method comprises layering of a cathode composition of any of the preceding embodiments, a separator material, the anode, and a electrolyte of any of the preceding embodiments. In some embodiments, said battery is a coin cell/pouch cell/full cell battery, etc.
25. A method of supplying power, said method comprising using a battery of any of the preceding embodiments to supply a voltage in the range of about 2 to about 5 V.

### 3.0 EXAMPLES

The following examples are provided solely to illustrate the present invention and are not intended to limit the scope of the invention, described herein.

### Example 1. Reversible Fluorine Chemistry

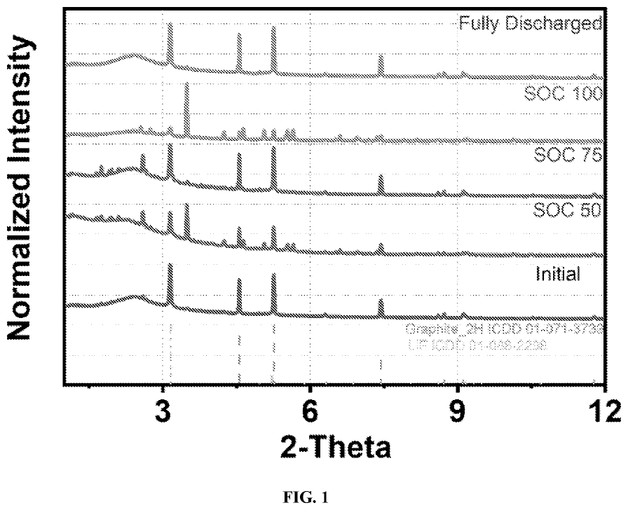

To investigate the reaction mechanism of the designed LiF—LiI-Graphite (FIG) electrode, X-ray diffraction (XRD) spectra were obtained ex-situ (FIG. 1). The initial FIG electrode shows a dominant LiF peak in addition to characterized peaks of graphite. Upon charging, the peak of LiF gradually decreases and almost completely disappears at 100% SOC, suggesting the conversion of LiF with the assistance of LiI. Once fully discharged, the LiF peak was again observed, indicating the reversible conversion of LiF.

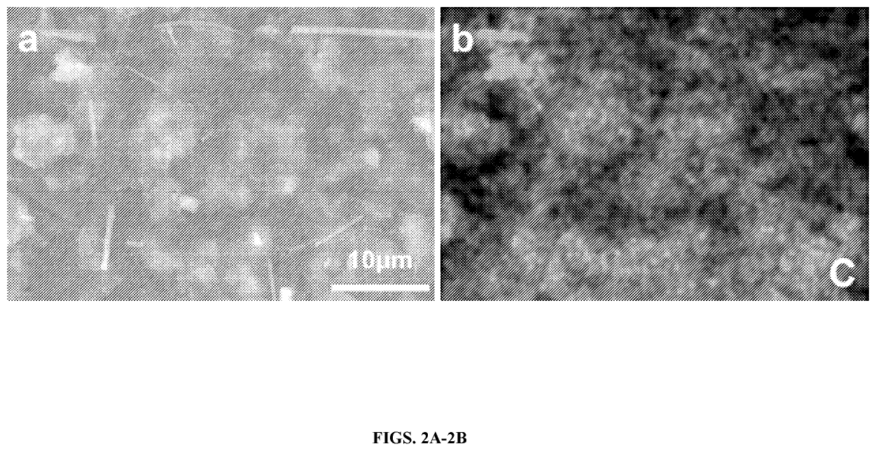

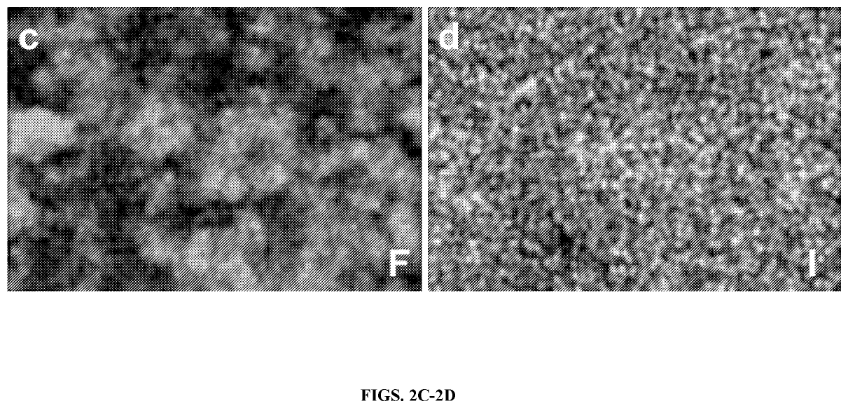

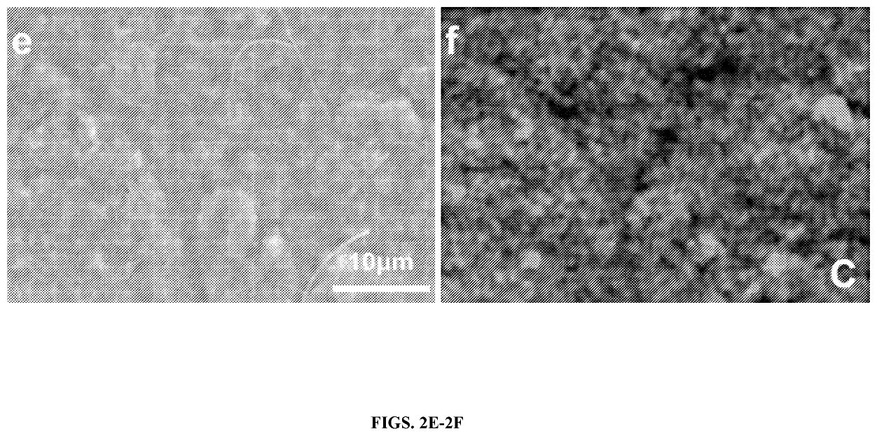

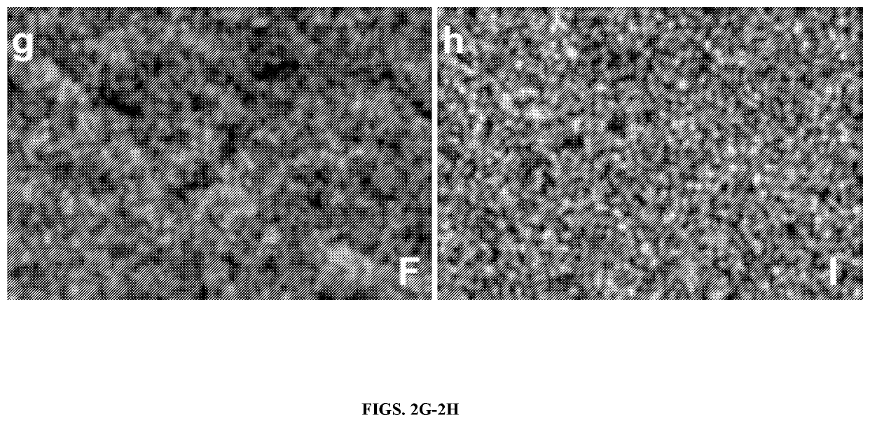

More details on the evolution of the FIG electrode were revealed in SEM images and EDS mappings. In the initial FIG electrode, LiF particles of ~10 μm can be observed (FIG. 2a-d). While at 100% SOC, micron-sized LiF particles are not visible and instead there is a uniform distribution of I and F elements. This phenomenon suggests that micron-sized LiF particles fully converse into interhalogens during the charging process. Both the XRD and SEM results indicate the successful electrochemical reactions of LiF by redox coupling with LiI.

### Example 2. Electrochemical Performance

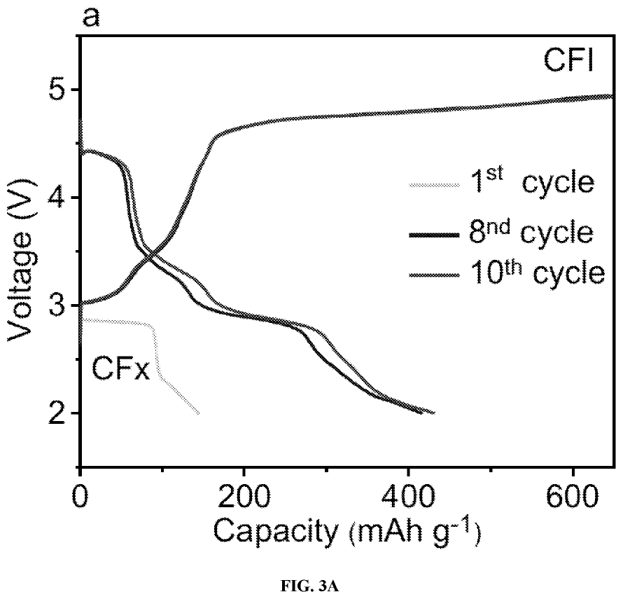

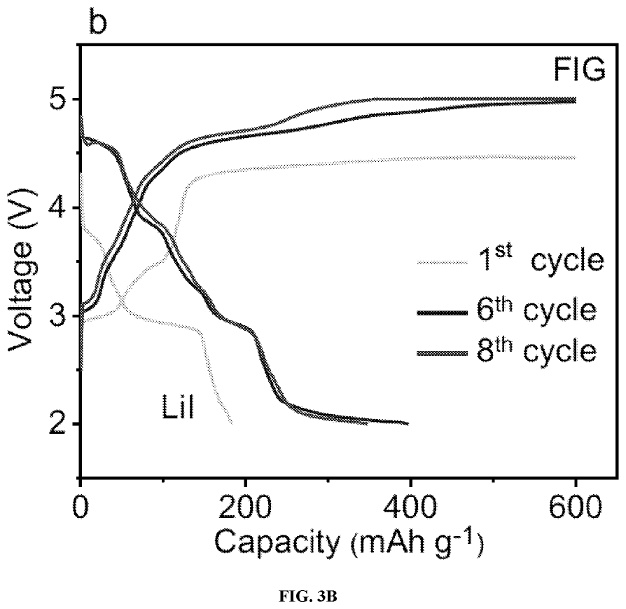

The electrochemical performance of the CFx—LiI (CFI) electrode was evaluated in CFI∥Li coin cells. According to FIG. 3a, the cell was discharged first, and the discharging capacity of the first cycle is up to 150 mAh/g, corresponding to the redox reaction of CFₓ+Li→LiF+C. Different from the primary CFₓ electrodes, these CFI electrodes are able to be recharged. Upon the cell charging to a higher voltage (>4.8V), the subsequent discharging capacity reaches ~430 mAh/g with a high discharge plateau of ~4.5V. In addition, the electrochemical performance of the LiF—LiI-Graphite (FIG) electrode was also evaluated in FIG∥Li coin cells. According to FIG. 3b, after charging to 4.5V, the discharging capacity of the first cycle is up to 180 mAh/g, corresponding to the redox reaction of LiI/I₂. Upon the cell charging to a higher voltage (>4.8V), the discharging capacity reaches ~400 mAh/g with a high discharge plateau of ~4.6V, indicating the formation of IFₓ. By taking a closer look at the charging curve, the reactions involve the oxidation of I⁻/I^{°} (~3.0V) and I^{°}/I⁺(~3.5 V), which share a similar voltage curve to the CFI electrode system.

Given low electronic and ionic conductivity, LiF has been regarded as an electrochemical inactive material at room temperature. For bare LiF, the calculated decomposition voltage is 6.1 V, which exceeds the electrochemical stability window of almost all nonaqueous electrolytes. Here, the LiF conversion is activated by the existence of LiI through redox coupling, thereby a lower oxidation potential for the conversion of LiF (~4.6V vs Li⁺/Li). By further tuning the electrolyte composition and optimizing the electrode materials, other redox coupling systems such as LiF—LiBr-G, and LiF—LiCl-G can be achieved.

### Example 3. Comparison to Commercial Electrolyte

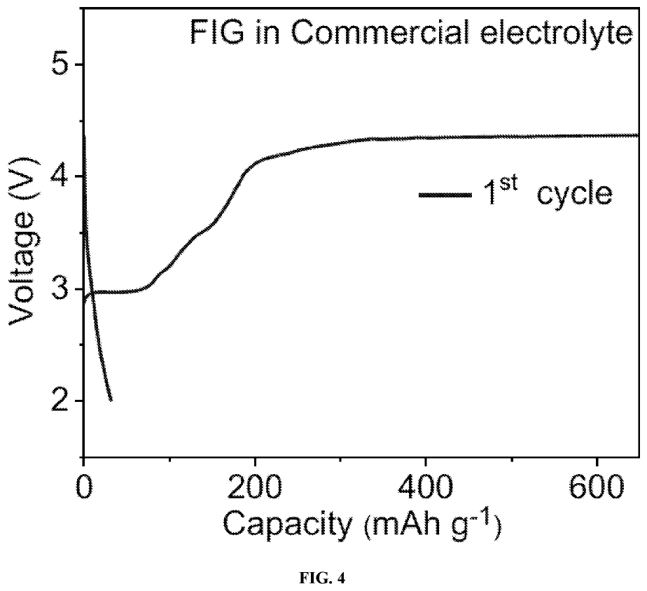

FIG. 4 describes the voltage-capacity curve of the FIG cathode in a commercial electrolyte (1M LiPF₆ in EC-DEC (50:50 by weight)). During charging, only the voltage plateau and capacity from LiI are observed. When the cell was charged to over 4V, where the capacity of LiI has been fully utilized, the cell went through a long voltage plateau and could not be charged to the designed cut-off voltage. After manually switching to the discharge step, there was no high-voltage plateau, and only part of the capacity from LiI could be reversibly discharged. This indicates that this electrode of the present disclosure cannot achieve reversible charge and discharge in the commercial electrolyte. Only by combining this electrode with a well-designed electrolyte can all active materials be reversible, thus achieving high energy density.

All publications mentioned herein are incorporated by reference to the extent they support the present invention.

### REFERENCES

A number of patents and publications are cited above in order to more fully describe and disclose the invention and the state of the art to which the invention pertains. Full citations for these references are provided below. Each of these references is incorporated herein by reference in its entirety into the present disclosure, to the same extent as if each individual reference was specifically and individually indicated to be incorporated by reference.
[1] Winter, M.; Barnett, B.; Xu, K., Before Li ion batteries. Chemical reviews 2018, 118, 11433-11456.
[2] Recham, N.; Chotard, J.-N.; Dupont, L., Delacourt, C.; Walker, W.; Armand, M.; Tarascon, J.-M., A 3.6 V lithium-based fluorosulphate insertion positive electrode for lithium-ion batteries. Nature materials 2010, 9, 68-74.
[3] Okubo, M.; Ko, S.; Dwibedi, D.; Yamada, A., Designing positive electrodes with high energy density for lithium-ion batteries. Journal of Materials Chemistry A 2021, 9, 7407-7421.
[4] Amatucci, G. G.; Pereira, N., Fluoride based electrode materials for advanced energy storage devices. Journal of Fluorine Chemistry 2007, 128, 243-262.
[5] Sayahpour, B.; Hirsh, H.; Bai, S.; Schorr, N. B.; Lambert, T. N.; Mayer, M.; Bao, W.; Cheng, D.; Zhang, M.; Leung, K., Revisiting discharge mechanism of CFx as a high energy density cathode material for lithium primary battery. Advanced Energy Materials 2022, 12, 2103196.
[6] Han, S. S.; Yu, T. H.; Merinov, B. V.; Van Duin, A. C., Yazami, R., Goddard III, W. A., Unraveling structural models of graphite fluorides by density functional theory calculations. Chemistry of Materials 2010, 22, 2142-2154.
[7] Watanabe, N.; Nakajima, T.; Touhara, H., Graphite fluorides. Elsevier: 2013.
[8] Xu, J.; Pollard, T. P.; Yang, C.; Dandu, N. K.; Tan, S.; Zhou, J.; Wang, J., He, X., Zhang, X.; Li, A.-M., Lithium halide cathodes for Li metal batteries. Joule 2023, 7, 83-94.

1. A composite cathode composition, said composition comprising:
a. graphite;
b. a component chosen from a monocationic metal fluoride or CFₓ, and;
c. at least one salt chosen from MCl, MBr, MI, or a combination thereof;
wherein M may be Li⁺, Na⁺, K⁺, or other monocationic metals;
and wherein x is in the range of about 0.05 to about 1.1.

2. The composition of claim 1, wherein x is in the range of about 0.2 to 1.

3. The composition of claim 1, wherein said at least one salt is chosen from MI, MBr, MCl, or a combination thereof.

4. The composition of claim 1, wherein said salt is LiI, NaI, or KI, or a combination thereof.

5. The composition of claim 1, wherein said salt comprises particles.

6. The composition of claim 1, wherein said particles have a size in the range of about 1 nm to about 100 μm.

7. The composition of claim 1, wherein said composite electrode composition is substantially free of transition metals.

8. A liquid electrolyte, said liquid electrolyte comprising a partially fluorinated solvent system, one or more salts comprising large-sized anions, and one or more salt additives comprising small-sized lithium salts.

9. The liquid electrolyte of claim 8, wherein said partially fluorinated solvent system is chosen from methyl (2,2,2-trifluoroethyl) carbonate, ethyl-(2,2,2-trifluoroethyl) carbonate, fluoroethylene carbonate, bis(2,2,2-trifluoroethyl) ether, 1,2-bis(2-fluoroethoxy)ethane, methyl 3,3,3-trifluoropionate, methyl difluoroacetate, methyl 2,2-difluoro-2 (fluorosulfonyl)acetate, ethyl difluoroacetate, or combinations thereof.

10. The liquid electrolyte of claim 8, wherein said one or more salts comprising large-sized anions is chosen from LiNFSI, lithium tetraphenylborate tris(1,2-dimethoxyethane), lithium p-toluenesulfinate, lithium nonafluoro-1-butanesulfonate, lithium 1,1,2,2,3,3-hexafluoropropane-1,3-disulfonimide, lithium 2-[(4-methylpiperazin-1-yl)methyl]benzoate, lithium 4,5-dicyano-2-(trifluoromethyl)imidazol-1-ide, or combinations thereof.

11. The liquid electrolyte of claim 8, wherein said additives are chosen from LiPF₆, LiFSI, LiDFP, LiBF₄, LiTFSI, LiNO₃, lithium trifluoromethanesulfonate, or combinations thereof.

12. The liquid electrolyte of claim 8, wherein the concentration of said one or more salts and said one or more salt additives are in the range of about 0.05 M to about 7 M.

13. The liquid electrolyte of claim 8, wherein said liquid electrolyte is substantially free of water, or is free of water.

14. A battery, said battery comprising a cathode composition of any of the preceding claims and the liquid electrolyte of claim 8.

15. The battery of claim 14, said battery further comprising an anode.

16. The battery of claim 15, wherein the anode is chosen from Li metal, Li foil, and Li alloy foil.

17. (canceled)

18. (canceled)

19. The battery of claim 14, wherein said battery is rechargeable.

20. The battery of claim 14, wherein said battery has a charging capacity of about 200 to about 500 mAh/g and a discharge capacity of in the range of about 200 mAh/g to about 500 mAh/g.

21. (canceled)
